(19) United States
(12) Patent Application Publication
(10) Pub. No.: US 2024/0290535 A1
(43) Pub. Date: Aug. 29, 2024

(54) COIL ASSEMBLY AND METHOD OF MANUFACTURING SAME

(71) Applicant: Ford Motor Company, Dearborn, MI (US)

(72) Inventors: John Paul Modzel, Farmington Hills, MI (US); Shay Fox, Chicago, IL (US); Franco Leonardi, Dearborn Heights, MI (US); Angela Skupski, Wyandotte, MI (US); Ralph Conrad, South Lyon, MI (US)

(73) Assignee: Ford Motor Company, Dearborn, MI (US)

(21) Appl. No.: 18/175,942

(22) Filed: Feb. 28, 2023

(51) Int. Cl. H01F 27/30; H01F 41/06

(52) U.S. Cl. CPC H01F 27/306; H01F 41/06

(57) ABSTRACT

A coil assembly includes a mounting structure and a coil member. The mounting structure includes at least one surface and at least one locking member disposed on the at least one surface. The coil member is wound around a central axis of the mounting structure and secured to the at least one surface of the mounting structure by the at least one locking member.

### FIELD

The present disclosure relates to a coil assembly and a method of manufacturing same, and more particularly to a coil assembly having a mounting structure to facilitate winding and attaching of a coil member thereon and a method of manufacturing same.

### BACKGROUND

The statements in this section merely provide background information related to the present disclosure and may not constitute prior art.

In a material forming operation, such as a stamping operation, a stack of blanks is generally positioned in proximity to a stamping press and automatically fed by a material handling machine into a stamping press. The material handling machine, such as a material handling robot, may include an end-effector to grasp and lift the uppermost blank from the stack and feed the uppermost blank into the stamping press. The stamping press receives the blanks and forms the blanks into a desired shape.

To facilitate the grasping operation of the end-effector of the material handling robot, the stack of blanks may be de-stacked or separated by a magnetic field generator disposed next to the stack of blanks. The magnetic field generator generates a magnetic field, which induces an eddy current in the uppermost blank before or when the end-effector grasps the uppermost blank. The eddy current in the uppermost blank causes generation of a repulsive force, thereby separating the uppermost blank from stack.

The magnetic field generator typically includes a copper coil member through which electric current flows to generate a magnetic field. When the space is limited, the coil member may need be wound in a smaller radius/size, causing the coil member to kink and/or spring out of the shape needed for the coil member. Winding the coil member is even more difficult when a cooling conduit is provided through the copper coil member.

The present disclosure addresses the issues related to winding and mounting the coil member in an electric apparatus, such as a magnetic field generator.

### SUMMARY

In one form, a coil assembly is provided, which includes a mounting structure and a coil member. The mounting structure includes at least one surface and at least one locking member disposed on the at least one surface. The coil member is wound around a central axis of the mounting structure and secured to the at least one surface of the mounting structure by the at least one locking member.

In other features, the at least one locking member defines a spiral groove for receiving the coil member therein. The coil member is press-fit into the spiral groove. The mounting structure defines a central opening and the at least one surface is an annular surface surrounding the central opening. The mounting structure includes a plurality of body sections aligned along the central axis of the mounting structure. The plurality of body sections define a plurality of surfaces. The coil member is secured to the plurality of surfaces. As such, the coil member defines a plurality of coiled portions secured to the plurality of surfaces in different planes. The plurality of coiled portions each include a plurality of windings. The mounting structure further includes connecting members at adjacent ones of the plurality of body sections to maintain the plurality of body sections in a spaced position. The plurality of body sections each include an annular plate portion or a truncated cone portion. The truncated cone portions are joined along the central axis of the mounting structure. The coil member includes a tube body made of an electrically conducting material and a cooling channel in the tube body. The mounting structure is made of an insulating material. The coil member is electrically insulated by the mounting structure.

In another form of the present disclosure, a coil assembly is provided, which includes a mounting structure and a coil member. The mounting structure includes a plurality of body sections aligned along a central axis of the mounting structure. The plurality of body sections each define a central opening, an annular surface around the central opening, and a spiral groove on the annular surface. The coil member includes a plurality of coiled portions disposed in different planes and secured to the plurality of annular surfaces of the plurality of body sections.

In other features, the plurality of body sections each have a ring plate configuration or a truncated cone configuration. The body sections are connected along the central axis of the mounting structure.

In still another form of the present disclosure, a method of manufacturing a coil assembly is provided, which includes: manufacturing a mounting structure by 3D printing, the mounting structure including a plurality of surfaces arranged along a central axis of the mounting structure and a plurality of locking members on the plurality of surfaces; and winding a coil member on the plurality of surfaces, the coil member being secured to the plurality of surfaces by the plurality of locking members.

In other features, the mounting structure includes a plurality of body sections aligned along the central axis of the mounting structure. The method further includes: manufacturing the plurality of body sections and an interconnect in one printing process, the interconnect connecting the plurality of body sections; removing the interconnect to separate the plurality of body sections; and connecting the plurality of body sections to form the mounting structure. The mounting structure further includes a connecting member. The connecting member, the plurality of body sections and the interconnect are manufactured in the same printing process. The method further includes connecting the plurality of body sections along the central axis of the mounting structure after the interconnect is removed to separate the plurality of body sections. The locking members define a plurality of spiral grooves. The method further comprising pressing the coil member in the plurality of spiral grooves.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The present disclosure will become more fully understood from the detailed description and the accompanying drawings, wherein:

FIG. 1 is a perspective view of an electric apparatus including a coil assembly constructed in accordance with with the teachings of the present disclosure;

FIG. 2 is a perspective view of a mounting structure of a coil assembly of the electric apparatus of FIG. 1;

FIG. 3 is a perspective view of a lower portion of the mounting structure of FIG. 2;

FIG. 4 is a perspective view of an upper portion of a coil assembly of the electric apparatus of FIG. 1;

FIG. 5 is a perspective view of a lower portion of a coil assembly of the electric apparatus of FIG. 1;

FIG. 6 is a cross-sectional view of a coil member of the coil assembly of FIGS. 4 and 5;

FIG. 7 is a perspective view of a semi mounting structure manufactured by a method of manufacturing a coil assembly in accordance with the teachings of the present disclosure;

FIG. 8 is a perspective view of a variant of a coil assembly of the electric apparatus constructed in accordance with the teachings of the present disclosure;

FIG. 9 is a perspective view of a mounting structure of the coil assembly of FIG. 8;

FIG. 10 is a front view of the mounting structure of FIG. 9;

FIG. 11 is a top view of the mounting structure of FIG. 9;

FIG. 12 is a bottom view of the mounting structure of FIG. 9; and

FIG. 13 is a perspective view of a coil member of the coil assembly of FIG. 8.

Corresponding reference numerals indicate corresponding parts throughout the several views of the drawings.

### DETAILED DESCRIPTION

The following description is merely exemplary in nature and is not intended to limit the present disclosure, application, or uses.

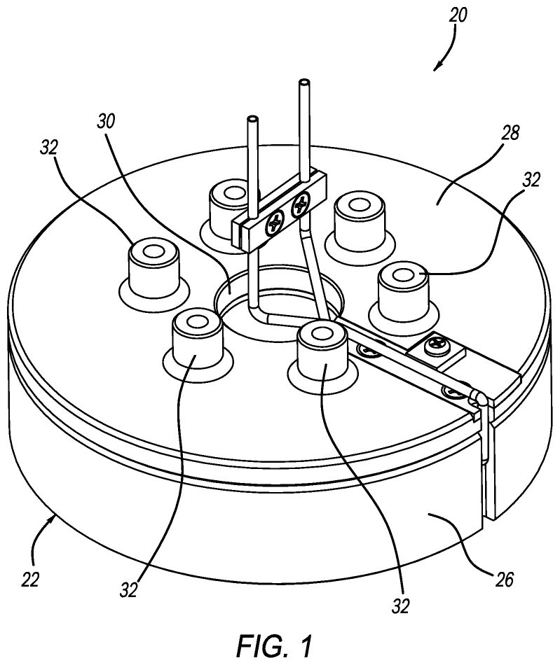

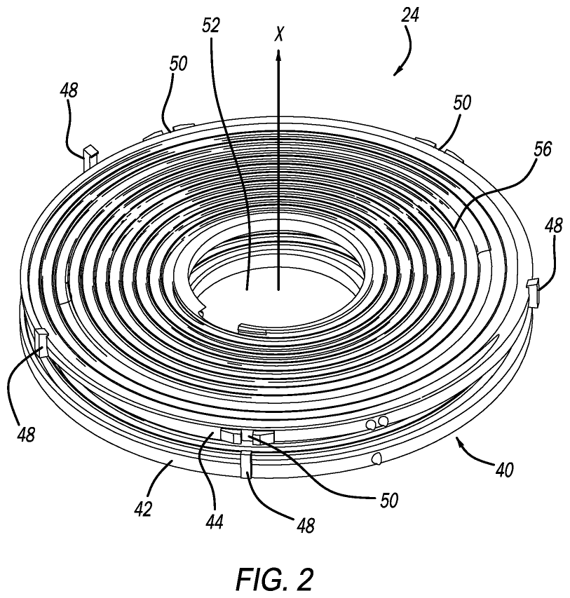

Referring to FIGS. 1 and 2, an electric apparatus 20 constructed in accordance with the teachings of the present application may be a magnetic field generator and generally include a housing 22 and a coil assembly 24 (shown in FIG. 2) disposed therein. The housing 22 includes a hollow cylindrical body 26 defining a hollow space for receiving the coil assembly 24 therein, and an end flange 28 mounted to an end of the hollow cylindrical body 26. The end flange 28 includes a central opening 30 and optionally a plurality of mounting bosses 32 for mounting the electric apparatus 20 to an adjacent component (not shown).

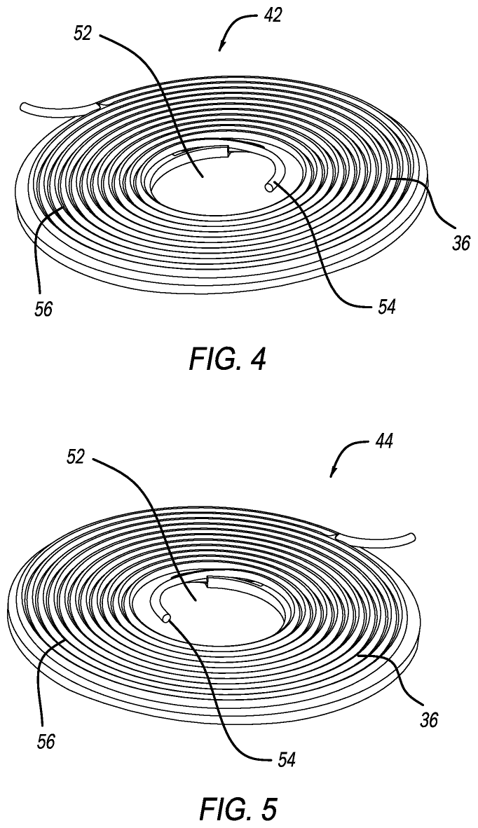

As clearly shown in FIGS. 2 to 5, the coil assembly 24 includes a coil member 36 (shown in FIGS. 4 and 5) and a mounting structure 40 on which the coil member 36 is attached. The mounting structure 40 includes a plurality of body sections aligned and spaced apart along a central axis X of the mounting structure 40 to allow the coil member 36 to be wound into a plurality of layers. For illustrative purposes, only two body sections, i.e., a first body section 42 and a second body section 44 are shown in FIG. 2. It is understood that the mounting structure 40 can include any number of body sections, including one, according to needs and/or the desired amount of magnetic flux provided by the electric apparatus 20.

The first and second body sections 42, 44 include connecting members for connecting the first and second body sections 42 and 44 and for maintaining the first and second body sections 42 and 44 in a spaced position. For example, the first body section 42 may include a plurality of keys 48 and the second body section 44 may include a plurality of keyways 50 for receiving the keys 48 of the first body section 42 such that the first and second body sections 42, 44 are properly aligned and connected. In addition, the second body section 44 may further include a plurality of keys 48 extending upwardly for engaging corresponding keyways 50 of a third body section (not shown) disposed immediately above the second body section 44.

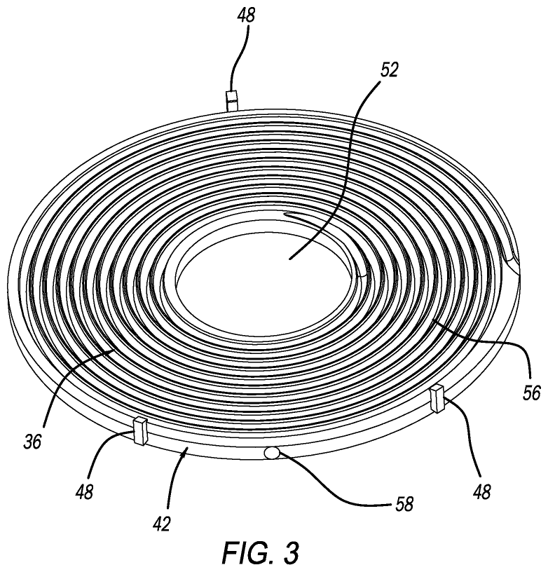

Referring to FIG. 3, the first body section 42 may include three keys 48 disposed at a periphery of the first body section 42, extending upwardly, and spaced apart at 120°. Similarly, as shown in FIG. 2, the second body section 42 may include three keyways 50 disposed at a periphery of the second body section 44 and spaced apart at 120°. The second body section 44 further includes three keys 48 disposed a periphery of the second body section 44 and spaced apart at 120° and spaced apart from the keyways 50 to be engaged to the third body section (not shown) disposed immediately above.

As further shown in FIGS. 2 and 3, the first and second body sections 42, 44 further include identifying features 58 that help an operator assemble the plurality of body sections in the right order. As an example, the first body section 42, the second body section 44, and the third body section (not shown), etc., may include one bead, two beads, three beads, etc., respectively, as an identifying feature 58 to identify the levels/layers of the plurality of body sections in the mounting structure 40.

As further shown, the first and second body sections 42, 44 may each has an annular plate configuration and define a central opening 52, an annular surface surrounding the central opening 52, and a locking member 56 disposed on the annular surface for mounting and fixing the coil member 36 thereon. As an example, as shown in FIGS. 2 to 5, the locking member 56 may define a continuous, spiral groove on the annular surface of each of the plurality of body sections for receiving the coil member 36 therein. Alternatively, while not shown in the drawings, the locking member 56 may define a plurality of discrete grooves for receiving the coil member 36 therein. In still another form, the locking member 56 may include a plurality pairs of clamping walls extending vertically from the annular surface for clamping the coil member 36 therebetween. It is understood that the locking member 48 may have any form as long as it can fix and mount the coil member 36 on the annular surfaces of the body sections 42, 44.

Referring to FIGS. 4 and 5, the central opening 52 of each of the first and second body sections 42, 44 allows a connecting portion 54 of the coil member 36 that is not wound and fixed on the annular surfaces of the body sections to extend through. As such, the coil member 36 is first wound on the first body section 42 and then is continuously wound on the second body section 44 and so on. The coil member 36 can be properly wound on the plurality of body sections of the mounting structure 40 while being secured on the annular surfaces of the body sections by the locking members 56, thereby preventing kinking of the coil member 36 even if the coil member 36 is wound into a spiral shape having a small radius/size. By using the mounting structure 40 having a plurality of body sections in different planes, the coil member 36 can be wound to have a plurality of coiled portions on the plurality of body sections. The plurality of coiled portions are disposed in different planes/levels, each having a plurality of windings on the same plane, i.e., on the same annular surface of each of the first and second body sections 42, 44. Therefore, the coil member 24 can have a low profile while providing strong magnetic flux. The mounting structure 40 may be made of electrically insulating material to provide electrical insulation for the coil member 36.

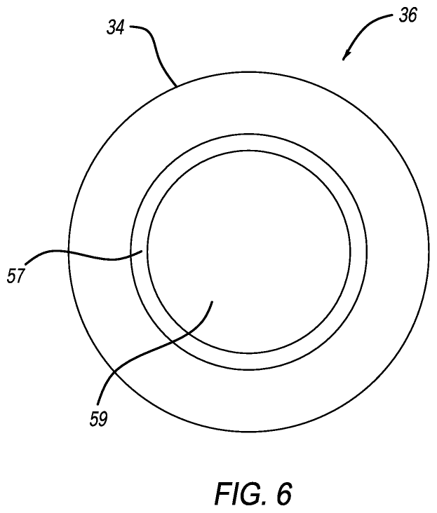

Referring to FIG. 6, the coil member 36 includes a tube body 34 and a fluid channel 57 disposed inside the tube body 34 for receiving a cooling medium 59. The tube body 34 is made of a conducting material, such as copper. The cooling medium 59 circulates inside the fluid channel 57 and provides cooling for the coil member 36.

Referring back to FIGS. 4 and 5, the mounting structure 40 including the body sections 42, 44 and the locking members 56 are made of an electrically insulating material. As such, the coil member 36 is electrically insulated by the mounting structure 40 when press-fit into the groove defined by the locking members 56 of the mounting structure 40.

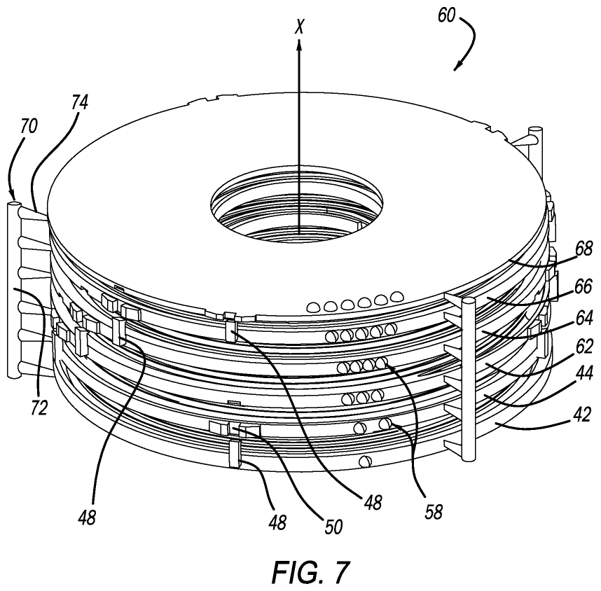

Referring to FIG. 7, the plurality of body sections that make up the mounting structure 40 may be formed in one 3D printing process, followed by assembling the plurality of body sections to form the final mounting structure. FIG. 7 shows a semi mounting structure 60 including five body sections (e.g., a first body section 42, a second body section 44, a third body section 62, a fourth body section 64, and a fifth body section 66) and an end plate 68. The first to fifth body sections 42, 44, 62, 64, 66 and the end plate 68 are sequentially formed by a 3D printing process and are connected by a removable interconnect 70. The removable interconnect 70 is formed in the same 3D printing process, concurrently with forming of the body sections 42, 44, 62, 64, 66 and the end plate 68. The removable interconnect 70 and the body sections 42, 44, 62, 64, 66 and the end plate 68 are formed as a one-piece component.

The removable interconnect 70 may have a comb configuration including a shaft 72 extending in a direction parallel to the central axis X of the body sections and a plurality of teeth 74 extending from the shaft 72 toward the plurality of body sections 42, 44, 62, 64, 66 and the end plate 68 in a radial direction and joined to the plurality of body sections 42, 44, 62, 64, 66 and the end plate 68. The teeth 74 of the removable interconnect 70 are configured to have a small size/thickness such that the removable interconnect 74 can be easily separated from the body sections 42, 44, 62, 64, 66 and the end flange 78 after the semi mounting structure 60 is formed by 3D printing.

During printing of each of the body sections 42, 44, 62, 64, 66, the locking members 56, the connecting members such as the keys 48 and the keyways 50, and the identifying features 58 (such as beads) for each body section are simultaneously formed. The keys 48 and the keyways 50 in the adjacent body sections are not engaged when the body sections are joined to the removable interconnect 70 during the printing process. It is understood that the end plate 68 does not need to have locking members formed on its surface.

After the semi mounting structure 60 is formed, the removable interconnect 70 is removed to separate the body sections 42, 44, 62, 64, 66 and the end plate 68 apart. The coil member 36 is then wound and attached to the annular surface of each of the body sections 42, 44, 62, 64, 66. The body sections 42, 44, 62, 64, 66 are then aligned and connected along the central axis X of the mounting structure 40 by using the connecting members (i.e., the keys 48 and keyways 50). The identifying feature 58 on each of the body sections 42, 44, 62, 64, 66 and the end plate 68 help an operator assemble and connect the body sections 42, 44, 62, 64, 66 and the end plate 68 in the right order, i.e., from bottom to top.

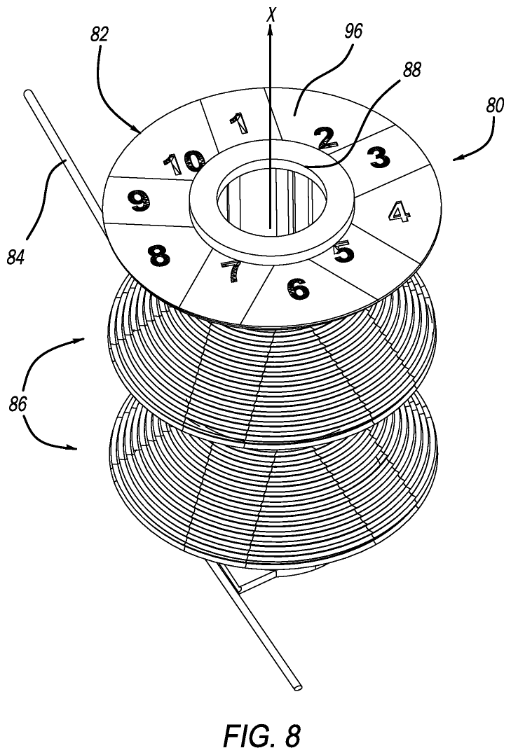

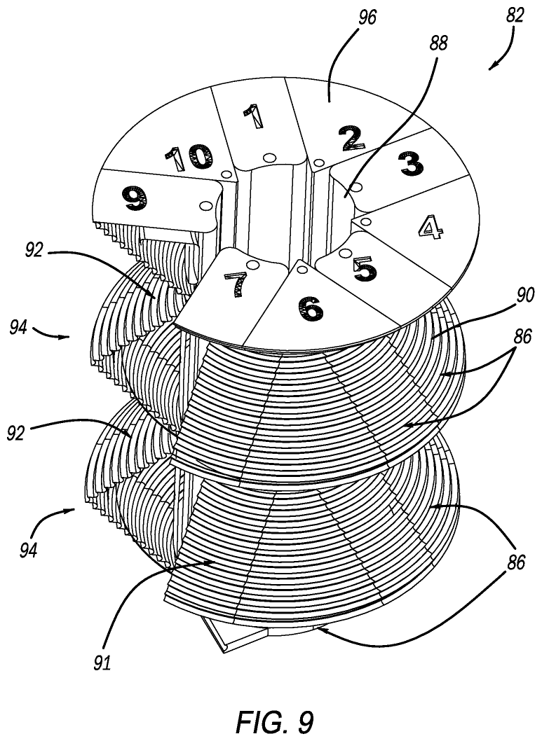

Referring to FIGS. 8 to 9, a variant of a coil assembly 80 in accordance with the teachings of the present application is shown. The coil assembly 80 includes a mounting structure 82 and a coil member 84 mounted thereon. The mounting structure 82 includes a plurality of body sections 86 in the form of truncated cones. The body sections 86 are aligned and joined at their opposing ends along the central axis X of the mounting structure 82. The body sections 86 each define a central opening 88, an annular slant surface 90 (shown in FIG. 9) around the central opening 88, and a locking member 91 formed on the annular slant surface 90. The coil member 84 may have a structure similar to the coil member 36 shown in FIG. 6. The locking member 91 on each body section may define a continuous, spiral groove to allow the coil member 84 to be press-fit therein. Alternatively, the locking member 91 may define a plurality of discrete grooves or may include a plurality pairs of clamping walls for clamping the coil member 84 therebetween.

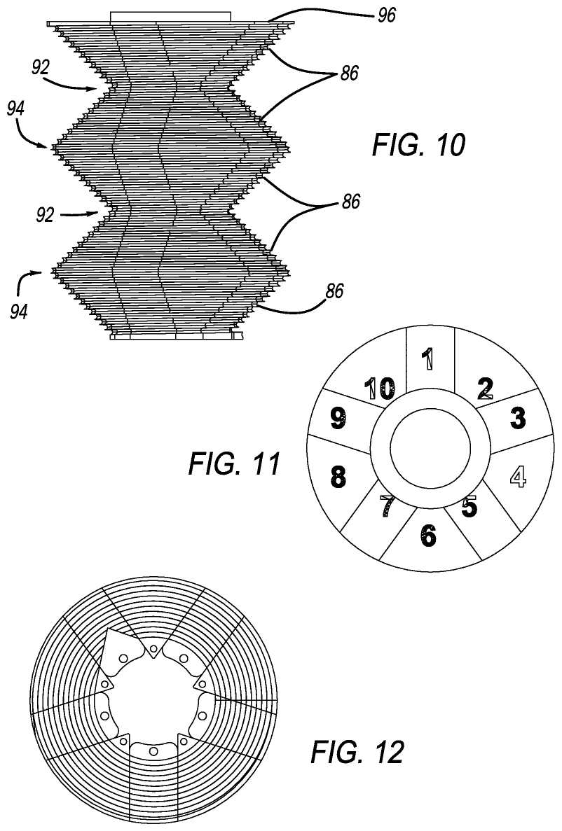

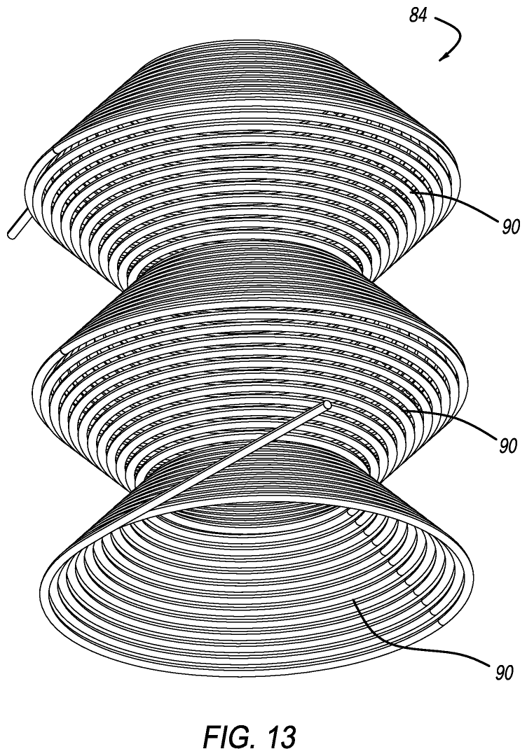

Referring to FIGS. 10 to 12, the body sections 86 are in the form of truncated cones, each include a smaller end 92 and a larger end 94 along the central axis X of the mounting structure 82. The smaller ends 92 of adjacent body sections 86 are joined together and the larger ends 94 of adjacent body sections 86 are joined together. The mounting structure 82 further includes an end plate 96 joined to the top-most body section. The end plate 96 may include a clamping structure for securing the opposing ends of the coil member 84.

Similarly, the mounting structure 82 may be manufactured by 3D printing as described in connection with FIG. 7. Since the body sections 86 and the end plate 96 that make up the mounting structure 82 are configured to be joined together, no connecting members, identifying features, and removable interconnect need to be formed. The locking members 56 are concurrently formed with the body sections 86 in the same printing process.

Referring to FIG. 13, the coil member 84 that is wound on the mounting structure 82 is shown to define a plurality of hollow truncated cone portions 90 that are joined and aligned along a central axis of the coil member 84 (same as the central axis X of the mounting structure) with a larger end of a hollow truncated cone portion 90 joined to a larger end of an adjacent hollow truncated cone portion 90 and with a smaller end of a hollow truncated cone portion 90 joined to a smaller end of an adjacent truncated cone portion 90. Therefore, the coil member 84 has a varied radius along the central axis of the coil member 84 and defines a wave configuration in a plan view.

Similarly, while not clearly shown in the drawings and as previously described in connection with FIGS. 4 and 5, the coil member 36 mounted on the mounting structure having a plurality of body sections 42, 44 as shown in FIGS. 2, 4 and 5 will define a plurality of coiled portions in the form of ring portions that are disposed in different planes and are aligned along a central axis of the coil member. The coiled portions each include a plurality of windings and are connected by the connecting portion 54 of coil member 36 located in the central opening 52.

According to the disclosure of the present application, the coil assembly 24, 80 of the electric apparatus 20 includes a mounting structure 40 or 82 to facilitate mounting and winding of a coil member 36 or 84 thereon. The mounting structure 40 or 82 includes a plurality of body sections and locking members 56, 91 on the body sections to allow the coil member 36 or 84 to be wound into a plurality of coiled portions in different planes and aligned along a central axis of the coil member 36 or 84. The plurality of coiled portions may be a plurality of ring portions or a plurality of hollow truncated cone portions. Each coiled portion has a plurality of windings. The locking members 56, 91 facilitate winding and mounting of the coil member 36 or 84 on the mounting structure 40 or 82 while preventing kinking of the coil member 36 or 84. Therefore, the coil member 36 or 84 can be wound into a relatively smaller radius/size and the number of windings can be increased even if the space is limited or even if the coil member has a relatively large size due to the inclusion of a cooling channel therein. Moreover, the mounting structure can be easily manufactured by one 3D printing process, thereby reducing the manufacturing costs.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A coil assembly comprising:
a mounting structure including at least one surface and at least one locking member disposed on the at least one surface; and
a coil member wound around a central axis of the mounting structure and secured to the at least one surface of the mounting structure by the at least one locking member.

2. The coil assembly according to claim 1, wherein the at least one locking member defines a spiral groove for receiving the coil member therein.

3. The coil assembly according to claim 2, wherein the coil member is press-fit into the spiral groove.

4. The coil assembly according to claim 1, wherein the mounting structure defines a central opening and the at least one surface is an annular surface surrounding the central opening.

5. The coil assembly according to claim 1, wherein the mounting structure includes a plurality of body sections aligned along the central axis of the mounting structure.

6. The coil assembly according to claim 5, wherein the plurality of body sections define a plurality of surfaces, the coil member being secured to the plurality of surfaces.

7. The coil assembly according to claim 5, wherein the coil member includes a plurality of coiled portions secured to the plurality of surfaces and disposed in different planes.

8. The coil assembly according to claim 7, wherein the plurality of coiled portions each include a plurality of windings.

9. The coil assembly according to claim 5, wherein the mounting structure further includes connecting members at adjacent ones of the plurality of body sections to maintain the plurality of body sections in a spaced position.

10. The coil assembly according to claim 5, wherein the plurality of body sections each include an annular ring portion or a truncated cone portion.

11. The coil assembly according to claim 10, wherein the truncated cone portions are joined along the central axis of the mounting structure.

12. The coil assembly according to claim 1, wherein the coil member includes a tube body made of an electrically conducting material and a cooling channel in the tube body.

13. The coil assembly according to claim 1, wherein the mounting structure is made of an insulating material, the coil member being electrically insulated by the mounting structure.

14. A coil assembly comprising:
a mounting structure including a plurality of body sections aligned along a central axis of the mounting structure, the plurality of body sections each defining a central opening, an annular surface around the central opening, and a spiral groove on the annular surface; and
a coil member including a plurality of coiled portions disposed in different planes and secured to the annular surfaces of the plurality of body sections by pressing the coiled portions into the spiral grooves of the body sections.

15. The coil assembly according to claim 14, wherein the plurality of body sections each have a ring plate configuration or a truncated cone configuration.

16. The coil assembly according to claim 14, wherein the body sections are connected along the central axis of the mounting structure.

17. A method of manufacturing a coil assembly, comprising:
manufacturing a mounting structure by 3D printing, the mounting structure including a plurality of surfaces arranged along a central axis of the mounting structure and a plurality of locking members on the plurality of surfaces; and
winding a coil member on the plurality of surfaces, the coil member being secured to the plurality of surfaces by the plurality of locking members.

18. The method according to claim 17, wherein the mounting structure includes a plurality of body sections aligned along the central axis of the mounting structure, the method further comprising:
manufacturing the plurality of body sections and an interconnect in one printing process, the interconnect connecting the plurality of body sections; and
removing the interconnect to separate the plurality of body sections.

19. The method according to claim 18, further comprising connecting the plurality of body sections to form the mounting structure after the interconnect is removed.

20. The method according to claim 18, wherein the mounting structure further includes a connecting member for connecting the plurality of body sections, wherein the connecting member, the plurality of body sections and the interconnect are manufactured in the same printing process.
